(19) United States
(12) Patent Application Publication
(10) Pub. No.: US 2005/0275618 A1
(43) Pub. Date: Dec. 15, 2005

(54) Pointing device

(75) Inventors: Sung Chul Juh, Seoul (KR); Yoon Soo Kim, Seoul (KR); Seung Hai Oh, Gyeonggi-do (KR); Kyu Deuk Cho, Seoul (KR); Tae Woo Kim, Seoul (KR); Dong Jung Yong, Seoul (KR); Jae Young Jo, Seoul (KR)

Correspondence Address: GREENBLUM & BERNSTEIN, P.L.C., 1950 ROLAND CLARKE PLACE, RESTON, VA, 20191, US

(73) Assignee: MOBISOL INC., Seoul (KR)

(21) Appl. No.: 10/524,879

(22) PCT Filed: Apr. 12, 2004
(86) PCT No.: PCT/KR04/00840

§ 371 Date: Feb. 17, 2005

(30) Foreign Application Priority Data
Apr. 11, 2003 (KP) R10-2003-0022936

(51) Int. Cl. G09G 5/00

(52) U.S. Cl. 345/156

(57) ABSTRACT

A pointing device to operate a portable electronic device using a finger is disclosed. The pointing device comprises a light emitting means for illuminating a subject; a hole through which light from the light emitting means is transmitted; an image-acquisition area for taking an image of the subject from the transmitted light; an image-formation means for forming an image by focusing the light reflected from the image-acquisition area; a conversion means for converting the image formed by the image-formation means into an electric signal; and an operation means for detecting the change of the image and calculating the amount of the change using the electric signal output from the conversion means. The subject is preferably the surface of a finger, a lattice, or any perceivable pattern. The pointing device can be embodied on portable electronic devices such as cellular phones and PDAs because it is small in size.

### TECHNICAL FIELD

The present invention relates to a pointing device and, more particularly, to a pointing device to operate a handheld terminal using a finger.

### BACKGROUND ART

Pointing devices generally include XY tablets, trackballs and mouse that are used for stationary devices such as desktop computers, and touch screen panels (hereinafter referred to as “TSPs”) and touch pads that are used for portable electronic devices such as notebook computers.

The XY tablet is a means for calculating position variation of the magnetic field, which is generated by the flow of electric current, with a separate magnetic field sensor. In detail, electric currents are successively applied to a lattice consisting of two-dimensional conductors toward X or Y direction to generate a magnetic field. The XY tablet comprises a magnetic field sensor connected with an XY tablet body.

The trackball includes an appropriate fixing member to prevent a rolling spherical ball from getting derailed, and at least two rotation speed detectors that detect the rotation of the ball. The trackball represents the rotation of the ball as two-dimensional movement using the rotation speed detectors.

The ball mouse is a device applying the principle of the trackball by contraries. In the ball mouse, instead of a ball, the trackball device itself moves to rotate the ball relatively. Therefore, the ball mouse represents the two-dimensional movement using the movement of the trackball device itself.

The TSP includes two flat resistance films positioned adjacently each other. If a user presses the panel with a sharp-end means such as a ball-point-pen, the resistance films in the pressed point contact each other to form a resistance circuit. Through an appropriate combination of these circuits, the position of contact between the resistance films can be calculated two-dimensionally.

FIG. 1 is a schematic diagram illustrating a conventional optical mouse device. As shown in FIG. 1, the optical mouse device has a two-dimension optical sensor array (10) that comprises CMOS image sensors (hereinafter referred to as “CIS”). In addition, an optical means (15) such as a lens is added to the two-dimension optical sensor array (10) to perceive relative coordinates of the mouse position through reflective light from a surface (20). There is no change of the coordinates if the optical mouse is not moved. If the optical mouse moves, the coordinates of the optical mouse change.

Such an optical mouse device calculates the movement distance of the optical mouse using an appropriate operation means (25) and a motion detector (30) based on the coordinate change. Particularly, in order to determine the movement distance, the motion detector (30) adopts a motion estimation method. The conventional optical mouse sends light through a hole (40) formed through the bottom of its casing (35) toward the surface (20) of an object on which the optical mouse is positioned. The light emitting means is generally a light emitting diode (LED). In addition, the conventional optical mouse device adopts a structure to minimize errors caused by specular light directly reflected from the surface (20).

However, these conventional pointing devices have several disadvantages. For example, the TSP can activate a desired icon by pressing the icon with a sharp-end tool to operate a machine. However, the TSP requires users to use both hands, holding the TSP by one hand and using the sharp-end tool by the other hand. In addition, users are disabled to use the TSP whenever the sharp-end tool is mislocated or not available. The ball mouse and optical mouse are difficult to be applied to portable electronic devices of small size because of the intrinsic limitations of their movement structure.

FIG. 2 shows an example of a portable electronic device having a conventional pointing device. Although FIG. 2 shows a notebook with a pointing device, all portable electronic devices including PDA (personal digital assistance) as well as the notebook can employ the pointing device. As shown in FIG. 2, the notebook (50) has a flat-panel display and GUI (graphic user interface) to maximize user's convenience. Users need to use a pointing device such as a touch pad (70), a TSP or a mouse to utilize GUI of the portable electronic device.

However, in the conventional portable electronic devices, a considerable part in the top area has to be assigned to the touch pad. As an alternative, the mouse device can be coupled to a connection port of the portable electronic device, but, in this case, the user has to carry separately the mouse with the portable electronic device.

Korean Patent Publication No. 2002-14430 discloses a portable wireless information terminal having a pointing device to effectively utilize application programs under the GUI environment. In the above-mentioned portable wireless information terminal, the pointing device, which includes a ball and a sensor for sensing rotational position, is mounted on the lower side of the information terminal to freely move a cursor on an LCD (liquid crystal display).

However, the above-mentioned prior art has a problem that it is restricted to a ball mouse because the pointing device employs a ball installed in a concave groove of a housing. In addition, the ball is protruded outside from the lower side of the portable terminal, thereby causing inconvenience in use.

### DISCLOSURE OF INVENTION

The present invention provides a pointing device comprising a light emitting means for illuminating a subject; a hole through which light from the light emitting means is transmitted; an image-acquisition area for taking an image of the subject from the transmitted light; an image-formation means for forming an image by focusing the light reflected from the image-acquisition area; a conversion means for converting the image formed by the image-formation means into an electric signal; and an operation means for detecting the change of the image and calculating the amount of the change using the electric signal output from the conversion means. Here, the subject is preferably the surface of a finger, a lattice, or any perceivable pattern.

In a second embodiment, the present invention provides a pointing device comprising a light emitting means; a light guide structure for guiding light from the light emitting means to a subject; an image-acquisition area for taking an image of the subject from the guided light; an image-formation means for forming an image by focusing the light reflected from the image-acquisition area; a conversion means for converting the image formed by the image-formation means into an electric signal; and an operation means for detecting the change of the image and calculating the amount of the change using the electric signal output from the conversion means. Here, the subject is preferably the surface of a finger, a lattice, or any perceivable pattern.

As a third embodiment, the present invention provides a pointing device comprising a light emitting means; a light guide structure for guiding light from the light emitting means to a subject; an image-acquisition area for taking an image of the subject from the guided light; an image-formation means for forming an image by focusing the light reflected from the image-acquisition area; a housing coupled to the image-formation means; a conversion means for converting the image formed by the image-formation means into an electric signal; a printed circuit board on which the conversion means is fixed; a cover for protecting the light emitting means, the image-formation means, the housing, the conversion means, and the printed circuit board; and an operation means for detecting the change of the image and calculating the amount of the change using the electric signal output from the conversion means.

### BRIEF DESCRIPTION OF THE DRAWINGS

Further objects and advantages of the invention can be more fully understood from the following detailed description taken in conjunction with the accompanying drawings, in which:

FIG. 1 is a schematic diagram illustrating a conventional optical mouse device;

FIG. 2 shows an example of a portable electronic device having a conventional pointing device;

FIG. 3 is a schematic diagram illustrating a pointing device according to an embodiment of the present invention;

FIG. 4 is a schematic diagram illustrating a pointing device according to another embodiment of the present invention;

FIG. 5 is a schematic diagram illustrating a pointing device according to a third embodiment of the present invention;

FIG. 6 shows examples of subjects available for a pointing device according to the present invention;

FIG. 7 is a diagram illustrating how the pointing device of the present invention works;

FIG. 8 shows an example of portable electronic device mounted with a pointing device according to the present invention;

FIG. 9 is a schematic diagram illustrating a pointing device with a contact sensor according to the present invention;

FIG. 10 is a schematic diagram illustrating a two-dimensional pointing device with an integral structure;

FIG. 11 is a schematic diagram illustrating a pointing device according to another embodiment of the present invention; and

FIG. 12 shows an example of portable electronic device equipped with a pointing device according to the present invention.

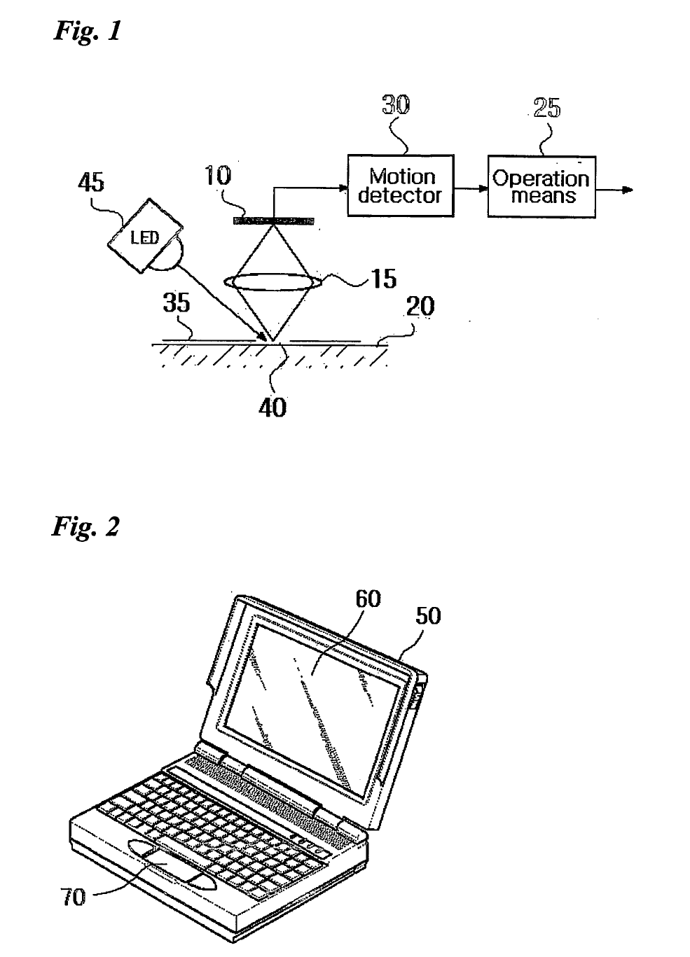

### REFERENCE

| | |
|---|---|
| 100, 440: light emitting means | 110: contact subject |
| 120, 400: image-formation means | 130, 150: conversion means |
| 140: motion detector | 150: operation means |
| 160: casing | 170: hole |
| 180: transparent plate | 190, 405: light guide structure |
| 300: portable electronic device | 310: pointing device |
| 320: mark | 330: selection button |
| 350: contact sensor | 360: control part |
| 410: housing | 420: printed circuit board |
| 430: cover | 500: pointing device module |
| 510: contact area | 520: switch |
| 530: screen | 540: pointer |

### BEST MODE FOR CARRYING OUT THE INVENTION

Reference will now be made in detail to the preferred embodiments of the present invention, examples of which are illustrated in the accompanying drawings.

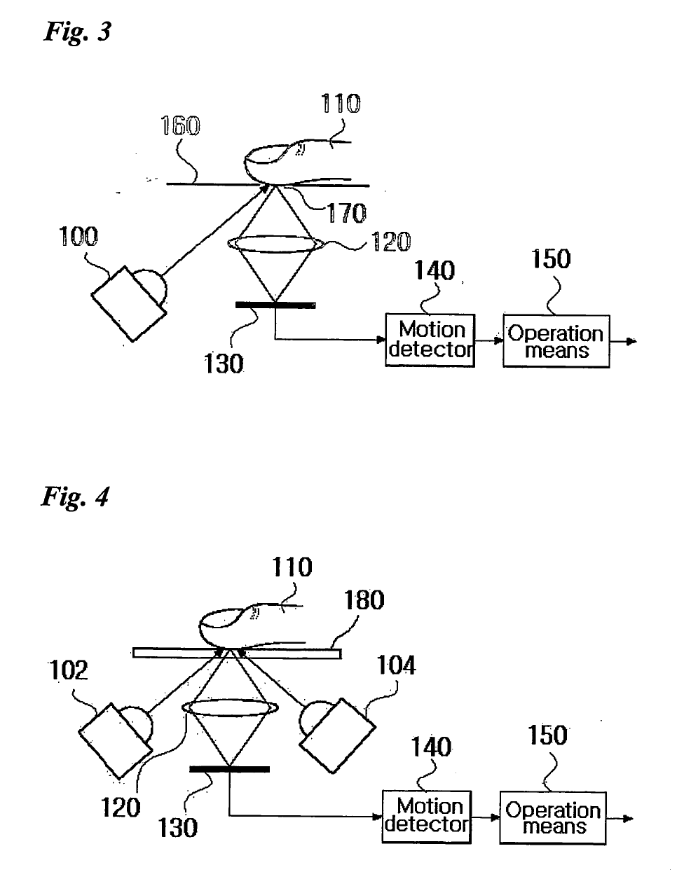

FIG. 3 is a schematic diagram of a pointing device in accordance with an embodiment of the present invention. Referring to FIG. 3, the pointing device of the present invention calculates the distance and direction for a pointer to be moved by acquiring and analyzing an image formed by light that is transmitted from a light emitting means (100) to a contact subject (110). This method presents a similar effect to that of an optical mouse, which moves on the fixed surface of a desk or a flat part. Here, the pointer means an indicator on a screen of display device, which is moved by a pointing device such as a mouse.

Such a pointing device is mounted on a portable electronic device and acquires changing images. In other words, a user can conveniently control a pointer on the screen of portable electronic device using the surface of his/her finger. The movement of a finger causes the change of image in the image-acquisition area. The distance and direction for the pointer to be moved can be calculated through the analysis of the change of image due to the movement of a finger.

The pointing device according to the present invention comprises a light emitting means (100), an image-acquisition area (not shown), an image-formation means (120), a conversion means (130), a motion detector (140), and an operation means (150). These component parts are described in detail.

The light emitting means (100) emits light to illuminate a contact subject (110) controlling a pointer. The contact subject (110) is preferably the surface of a user's finger, a lattice, or any perceivable pattern. The light emitting means (100) is preferably an LED, a laser diode, or an organic electroluminescence.

The image-acquisition area (not shown) acquires movement data using the light illuminated from the light emitting means (100). The image-acquisition area is positioned at a predetermined distance from the image-formation means (120). The image-acquisition area is preferably a housing with a transparent member whose surface in contact with the contact subject (110) is flat and made of transparent material. The housing is preferably coated to prevent the surface of the image-acquisition area from damage or contamination. Additionally, the image-acquisition area may be a virtual plane positioned at a predetermined distance from the image-formation means (120).

The image-formation means (120) forms an image on the opposite side by focusing the light reflected from the image-acquisition area. The image-formation means (120) may be an optical lens, preferably a spherical or non-spherical lens or a mirror.

The conversion means (130) detects the analog image formed by the image-formation means (120) and converts it into a digital image. The conversion means (130) is preferably an optical sensor array in which a plurality of CMOS image sensors or CCD (charge coupled device) image sensors are arranged in two-dimensional form.

The motion detector (140) perceives the extent of movement through the digital image received from the conversion means (130) using a motion estimation method. The motion detector (140) uses a motion estimator.

The operation means (150) receives the extent of movement, e.g., shift data from the motion detector (140) and calculates the distance and direction for the pointer to be moved. The operation means (150) is coupled to the pointing device or the processor of a machine on which the pointing device is mounted. Accordingly, the processor can control the pointer on the screen of a display device so that it can be freely moved toward a desired direction by a desired distance.

In FIG. 3, the reference number 160 is a casing of a pointing device or a casing of a portable electronic device equipped with the pointing device. The reference number 170 is a hole formed through the casing (160). The light from the light emitting means (100) is reflected from the finger surface through the hole (170).

For example, the light from a light emitting diode is illuminated onto the finger surface and reflected according to a pattern of the finger surface. The light reflected from the finger surface forms an image on the surface of the CMOS image sensor or CCD image sensor array through the lens. The formed image is converted into an electric signal by the CMOS image sensor or the CCD image sensor array and entered into a signal processing part to be changed into a digital image.

The above-mentioned image acquisition is performed very rapidly on a real-time base. The motion estimator detects the extent of change between images by comparing the images formed in two adjacent time sequences. The detected movement implies movement of a finger in the adjacent time sequences. Thus, the present invention can embody the pointing device such as a mouse device of a computer using the finger movement.

A conventional mouse device needs a large flat area on which the mouse device is moved, but the present invention can embody the pointing device within a small space by minimizing the size of the image-acquisition area.

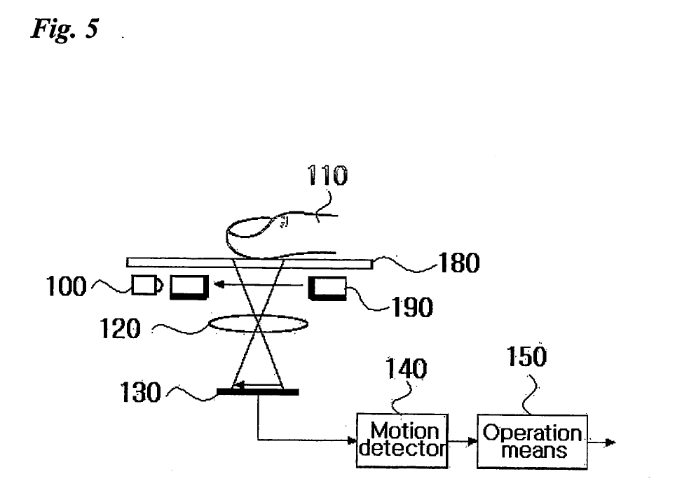

FIGS. 4 and 5 are schematic diagrams illustrating a pointing device according to embodiments of the present invention. The pointing device illustrated in FIG. 4 additionally comprises a transparent plate (180) and another LED (104) compared to the pointing device in FIG. 3.

In general, the change of distance between the finger surface and the image-acquisition area causes images to be unclear, thereby making the movement analysis difficult. However, by using the transparent plate (180) to shorten the focal length of lens, the pointing device of the present invention can avoid this problem. In detail, in order to maintain uniformly the distance between the contact subject and the image-acquisition area, the present invention employs the transparent plate (180) so that the finger moves on the flat area.

In addition, when the finger surface (110) moves, the dimension and position of the shadow of the finger may change to cause error because of an outside three-dimension lighting. This problem can be solved with two LEDs (102, 104).

Referring to FIG. 5, the pointing device additionally comprises a light guide structure (190). The light guide structure (190) transforms the light transmitted to the transparent plate (180) into the light similar to planar light, thereby minimizing error occurrence due to change of lighting conditions and distributing uniformly the light from the light emitting means (100) to constantly maintain desired brightness in the predetermined area. In addition, the factors related to the light guide structure (190) are adjusted appropriately in order to minimize transmission loss of light or image.

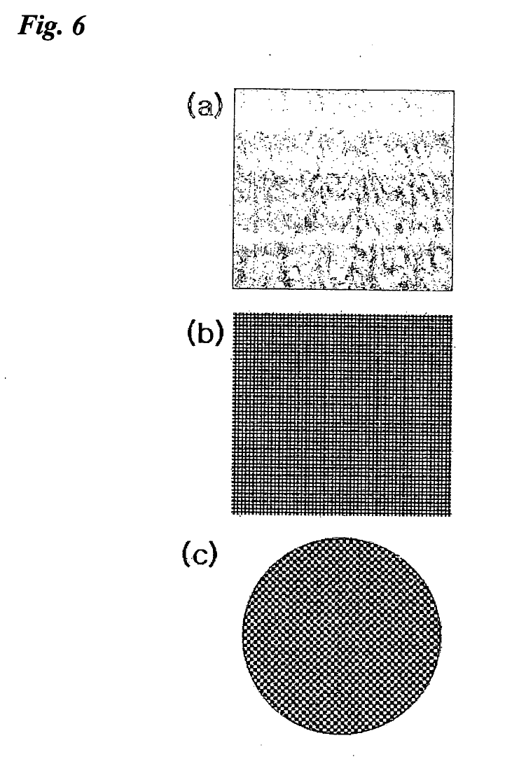

FIG. 6 shows examples of subjects available for a pointing device according to the present invention. In FIG. 6, (a) is the fingerprint of a finger, (b) is a lattice, and (c) is an example of any perceivable pattern. The pointing device in accordance with the present invention preferably uses the surface of a finger, a lattice or a perceivable pattern as the contact subject.

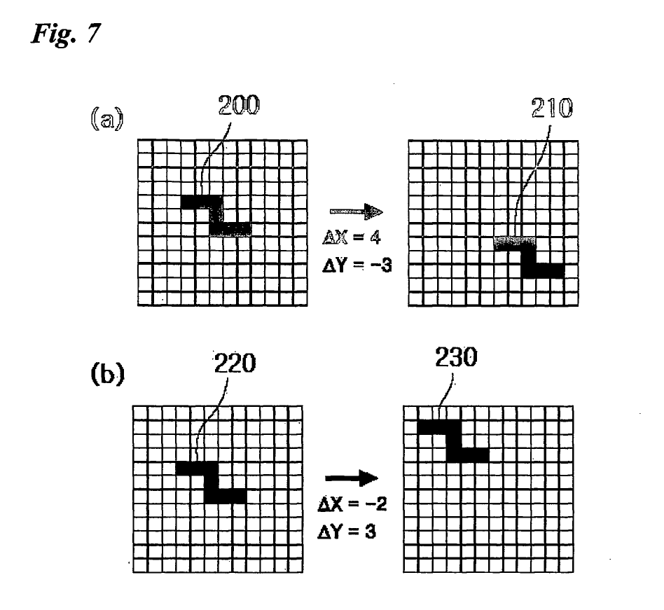

FIG. 7 is a diagram illustrating how the pointing device of the present invention works. In FIG. 7 (a), area A (200) is an image formed on a CMOS image sensor or a CCD image sensor at the initial time T=0 and area B (210) is an image after the area A (200) moves 4 pixels to the right and 3 pixels downward during a predetermined time T1. In FIG. 7 (b), area C (220) is an image formed on a CMOS image sensor or a CCD image sensor at the initial time T=O and area D (230) is an image after the area C (220) moves 2 pixels to the left and 3 pixels upward during a predetermined time T2. Thus, the pointing device in accordance with the present invention can recognize the direction and distance of a movement made.

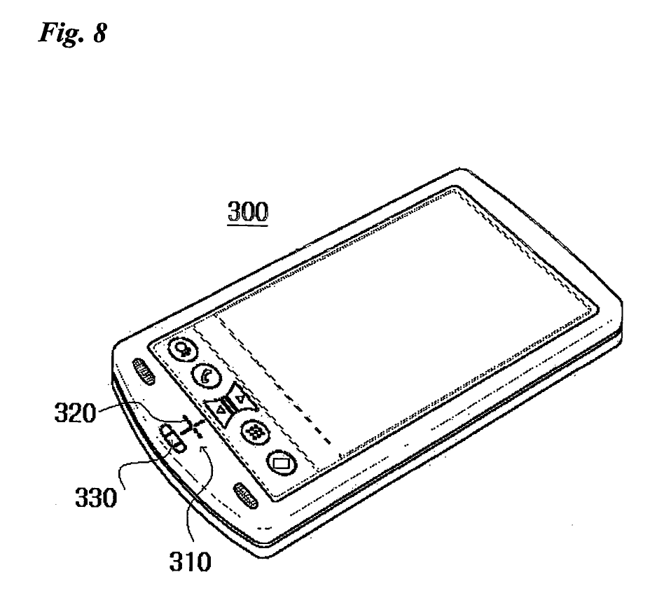

FIG. 8 shows a portable electronic device equipped with a pointing device according to the present invention. As shown in FIG. 8, the portable electronic device (300) includes a PDA. The PDA is equipped with the above-mentioned pointing device (310). The pointing device (310) is not exposed outside and a cross-shaped mark (320) is printed on the location of the pointing device (310) to represent the place on which a finger, for example, is positioned to control a pointer.

Preferably, the portable electronic device (300) additionally comprises at least a selection button (330) connected to the pointing device (310). The selection button (330) is used to select a target with the pointer moved by the pointing device (310) or to enter a command. Here, the portable electronic device (300) uses a secondary battery as a main power source.

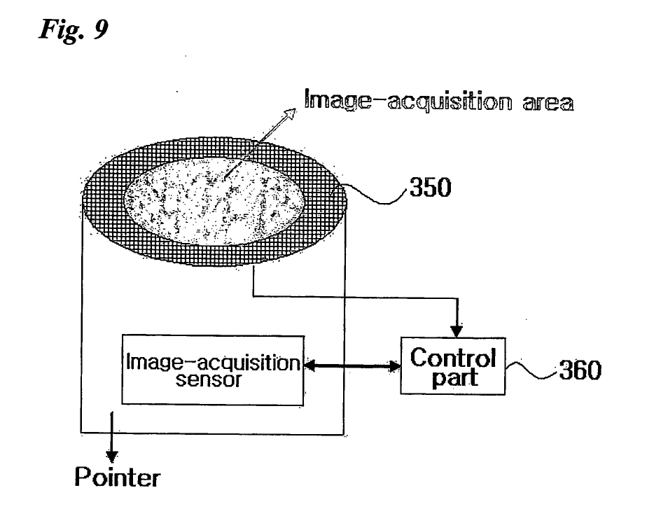

FIG. 9 is a schematic diagram illustrating a pointing device with a contact sensor according to the present invention. Preferably, the light emitting means in a portable electronic device has to be operated only during the use of the pointing device because a considerable electric power is required to operate the light emitting means. Therefore, as a means to determine if the pointing device is in use, a contact sensor (350) is attached around the image-acquisition area. When a finger touches the contact sensor (350) or is placed near the contact sensor (350), the control part (360) operates the light emitting means so that the pointing device begins to work. The contact sensor (350) may preferably perform the role of selection switch, which is similar to double-click of a conventional mouse device, for selecting the present position or a predetermined function indicated by a pointer, based on a predetermined time interval for which the finger touches. For the role of the selection switch, “contact”, “non-contact”, and “contact have to be performed in sequence in a short time interval.

The contact sensor (350) may be internally connected with on-off terminals of the conversion means and the light emitting means so as to control the on or the off state of the conversion means and the light emitting means according to the “contact” or “non-contact” status with the subject using hardware. The output of the contact sensor (350) may be connected with the control part (210) so as to control the on or the off state of the conversion means and the light emitting means using software.

In addition, the contact sensor (350) is preferably placed around the image acquisition area within a radius of about 3 cm from the center of the image acquisition area and can be embodied by both contact and non-contact fashion.

When a user employs a portable electronic device equipped with the pointing device, he or she may use a program that does not require the pointing device. In that case, he or she may push the contact sensor instead of a desired button by mistake. To avoid the accidental operation of the pointing device due to such a mistake, the portable electronic device with the pointing device may be programmed so that the contact sensor operates the pointing device in case of a program requiring the pointing device and the pointing device is turned off in case of a program requiring no pointing device.

For example, where a game using only arrow keys does not need the pointing device, the pointing device is automatically turned off by means of an appropriate programming while the game is displayed on a screen.

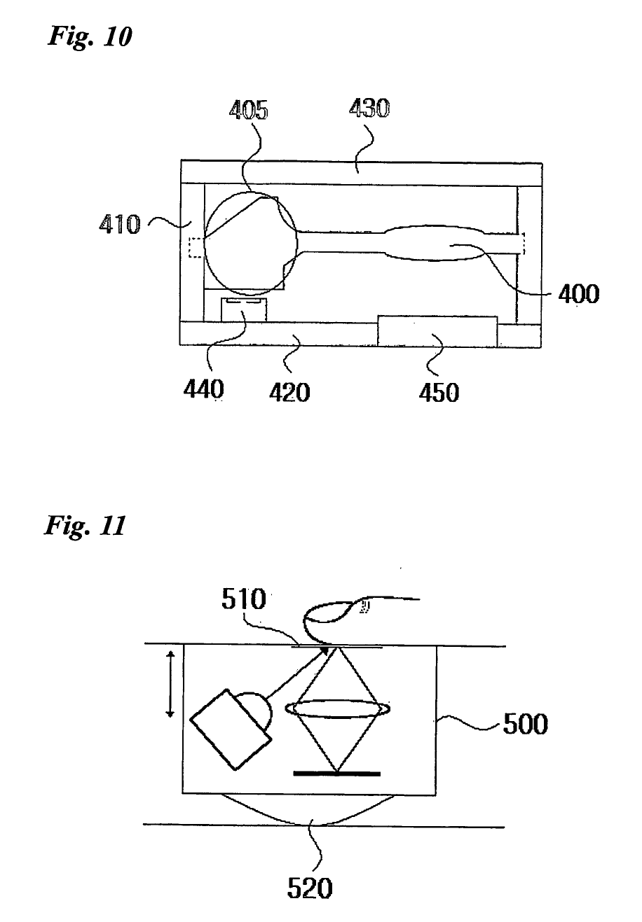

FIG. 10 is a diagram illustrating a two-dimensional pointing device with an integral structure. As shown in FIG. 10, the pointing device in accordance with the present invention is preferably used for small-sized portable electronic devices such as cellular phones and, therefore, the miniaturization of the pointing device is essential. It is desirable to unite the image-formation means (400) with the fixing frame (410). Preferably, it is desirable to unite the light guide structure (405), the image-formation means (400), and the housing (410) as an integral structure. The spherical or non-spherical lens is united into the integral structure as a part. Such an integral structure improves operation efficiency and productivity by minimizing occurrence of defectiveness due to tolerance in assembling.

A printed circuit board (420) is installed into the housing (410). The light emitting means (440), the conversion means (450), and parts containing circuits for operation are mounted on the printed circuit board (420). A cover (430) is used to maintain constantly the shape of the finger surface in contact with the area in the top of the pointing device. In addition, the cover (430) can protect the light emitting means (440), the image-formation means (400), the housing (410), the conversion means (450), and the printed circuit board (420) from contamination such as dust.

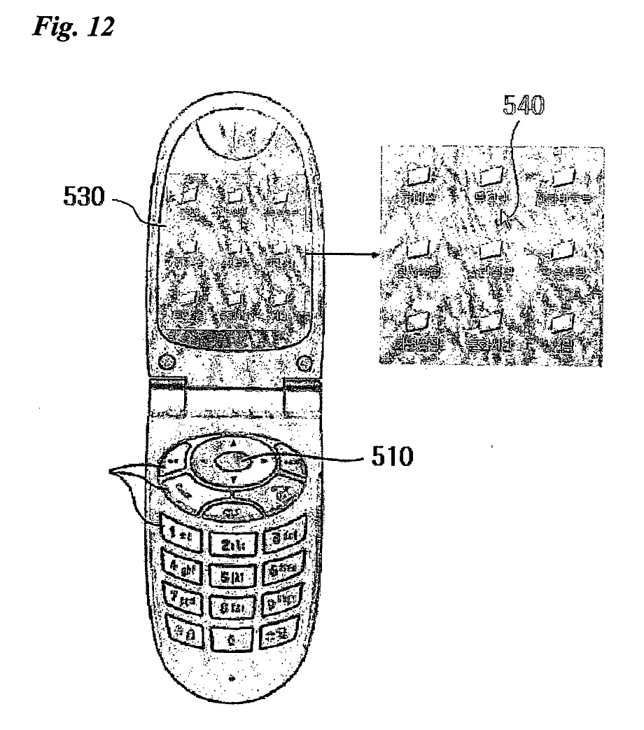

FIG. 11 is a schematic diagram illustrating a pointing device according to another embodiment of the present invention. FIG. 12 shows an example of a portable electronic device equipped with the pointing device according to the present invention.

As shown in FIGS. 11 and 12, the pointing device in a small-size portable electronic device such as a cellular phone is preferably embodied by the selection method using pressure. There is a contact area (510) on the top of the united pointing device module (500) and a switch (520) under the pointing device module (500). If the contact area (510) is pressed, the pointing device module (500) capable of moving up and down operates the switch (520). When the pointing device module (500) is pressed to operate the switch (520), a graphic icon indicated by a pointer (540) on a screen (530) is selected and, then, the corresponding function is performed.

On the other hand, the pointing device of the present invention may employ the surface of a palm, the surface of the back of a hand, and all types of objects with a surface similar to a finger surface as well as the finger surface as a means to control the pointer.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

### INDUSTRIAL APPLICABILITY

Thus, the pointing device in accordance with the present invention can be embodied in a small space through the minimization of the image-acquisition area. In addition, the pointing device needs not a mouse pad or a flat surface. The pointing device can be embodied on portable electronic devices such as cellular phones and PDAs because it is small in size.

1. A pointing device comprising:
a light emitting means for illuminating a subject selected from the group consisting of a surface of a finger, a lattice, and any perceivable pattern;
a hole through which light from the light emitting means is transmitted;
an image-acquisition area for taking an image of the subject from the transmitted light;
an image-formation means for forming an image by focusing the light reflected from the image-acquisition area;
a conversion means for converting the image formed by the image-formation means into an electric signal; and
an operation means for detecting the change of the image and calculating the amount of the change using the electric signal output from the conversion means.

2. A pointing device comprising:
a light emitting means;
a light guide structure for guiding light from the light emitting means to a subject selected from the group consisting of a surface of a finger, a lattice, and any perceivable pattern;
an image-acquisition area for taking an image of the subject from the guided light;
an image-formation means for forming an image by focusing the light reflected from the image-acquisition area;
a conversion means for converting the image formed by the image-formation means into an electric signal; and
an operation means for detecting the change of the image and calculating the amount of the change using the electric signal output from the conversion means.

3. The pointing device as defined by claim 1, wherein the light emitting means is selected from the group consisting of a light emitting diode, a laser diode, and an organic electroluminescence.

4. The pointing device as defined by claim 3, wherein the light emitting means comprises at least one light emitting diode.

5. The pointing device as defined by claim 1, wherein the conversion means is a CMOS image sensor or a CCD image sensor.

6. The pointing device as defined by claim 1, further comprising a selection button for selecting a target with a pointer moved by the pointing device or entering a command.

7. The pointing device as defined by claim 1, wherein the image-formation means is one selected from the group consisting of a spherical or non-spherical lens and a spherical or non-spherical mirror.

8. A pointing device comprising:
a light emitting means;
a light guide structure for guiding light from the light emitting means to a subject;
an image-acquisition area for taking an image of the subject from the guided light;
an image-formation means for forming an image by focusing the light reflected from the image-acquisition area;
a housing coupled to the image-formation means;
a conversion means for converting the image formed by the image-formation means into an electric signal;
a printed circuit board on which the conversion means is fixed;
a cover for protecting the light emitting means, the image-formation means, the housing, the conversion means, and the printed circuit board; and
an operation means for detecting the change of the image and calculating the amount of the change using the electric signal output from the conversion means.

9. The pointing device as defined by claim 8, wherein the subject is one selected from the group consisting of a surface of a finger, a lattice, and any perceivable pattern.

10. The pointing device as defined by claim 8, further comprising a contact sensor for determining whether the pointing device is in use.

11. The pointing device as defined by claim 10, wherein the contact sensor is embodied by means of a direct contact or non-contact fashion.

12. The pointing device as defined by claim 10, wherein the contact sensor controls an on-off state of the light emitting means or the conversion means based on whether the contact sensor is touched by a human body or an object.

13. The pointing device as defined by claim 10, wherein the contact sensor is positioned around the image-acquisition area within a radius of about 3 cm from the center of the image acquisition area.

14. The pointing device as defined by claim 10, wherein the contact sensor operates the pointing device only for a program requiring the pointing device.

15. The pointing device as defined by claim 10, wherein the contact sensor performs the role of a selection switch for selecting the present position on a predetermined function indicated by a pointer.

16. The pointing device as defined by claim 15, wherein the role of the selection switch is performed according to the change of time interval between contact and non-contact to the contact sensor.

17. The pointing device as defined by claim 8, wherein the light guide structure, the image-formation means, and the housing are united as an integral structure.

18. The pointing device as defined by claim 1, wherein the image-acquisition area is coated in order to prevent damage or contamination of the image-acquisition area.

19. The pointing device as defined by claim 1, wherein the operation means receives the electric signal from the conversation means and determines the distance and direction for a pointer to be moved by calculating the electric signal.

20. The pointing device as defined by claim 1, wherein the image-acquisition area is a transparent member or a virtual plane positioned at a predetermined distance from the image-formation means.
